(19) United States
(12) Patent Application Publication
(10) Pub. No.: US 2002/0073847 A1
(43) Pub. Date: Jun. 20, 2002

(54) Cell within a cell monolith structure for an evaporative emissions hydrocarbon scrubber

(76) Inventors: Matthew R. Sheline, Grand Blanc, MI (US); Charles H. Covert, Manchester, NY (US); Susan LaBine, Avon, NY (US); Jonathan M. Oemoke, Rochester, NY (US); Eileen A. Scardino, Rochester, NY (US)

Correspondence Address: Vincent A. Cichosz, DELPHI TECHNOLOGIES, INC., 1450 West Long Lake, Troy, MI, 48007, US

(21) Appl. No.: 09/738,558

(22) Filed: Dec. 15, 2000

(51) Int. Cl. B01D 53/02

(52) U.S. Cl. 95/143; 96/108

(57) ABSTRACT

A monolith for use in an evaporative emissions hydrocarbon scrubber is disclosed. The monolith, which is concentrically disposed with a shell, has at least one cell group disposed around at least two individual cells, such that the cell group comprises at least three thick walls. The individual cells comprise at least on thin wall, with the thick walls being thicker than the thin wall. A method for using the evaporative emissions hydrocarbon scrubber is also disclosed.

### TECHNICAL FIELD

The disclosure relates to the evaporative emissions from a gasoline tank in motor vehicles and, more particularly, to the scrubber used in filtering the evaporative emissions.

### BACKGROUND

Motor vehicles emit hydrocarbons as a result of the evaporation of fuel. Generally, such evaporative emissions result from the venting of fuel vapors from the fuel tank due to diurnal changes in ambient pressure and/or temperature, the vaporization of fuel by a hot engine and/or exhaust system, and the escape of fuel vapors during refueling of the vehicle. The venting of fuel vapor from the fuel tank due to diurnal pressure and/or temperature changes (i.e., diurnal emissions) is responsible for a majority of evaporative emissions. Diurnal changes in pressure and/or temperature cause air to flow into and out of the fuel tank. Air flowing out of the fuel tank inevitably carries fuel vapor, which is created by the evaporation of fuel into the air contained above the fuel within the fuel tank. If this flow of air is left untreated and is allowed to escape directly into the atmosphere, undesirable emissions occur.

Motor vehicle manufacturers have reduced the level of diurnal emissions through the use of evaporative canisters such as the evaporative canister structure and operation set forth in U.S. Pat. No. 5,910,637, the disclosure of which is incorporated herein by reference. Generally, an evaporative canister has a vapor inlet, a purge port and a vent port. The vapor inlet is fluidly connected by a vapor conduit to the air space in the fuel tank. Diurnal changes in pressure and/or temperature causes air within the fuel tank to flow through the vapor conduit and into the evaporative canister via the vapor inlet. The air carries fuel vapor and/or hydrocarbons. The evaporative canister contains a sorbent material, such as an activated carbon, that strips fuel vapor from the air as it flows through the canister. The treated air then flows out the vent port and into the atmosphere. The purge port is fluidly connected by a valved purge conduit to the combustion air intake of the motor vehicle engine. When the engine is running, the combustion air intake is at sub-atmospheric pressure, and the valve is opened to thereby connect the purge port to the combustion air intake. Fresh air is drawn by the sub-atmospheric pressure through the vent port and into the evaporative canister. The fresh air flows through the sorbent material, out the purge port and into the combustion air inlet. The flow of fresh air through the evaporative canister strips the sorbent material of stored fuel vapor and/or hydrocarbons, thereby purging the evaporative canister of hydrocarbons.

Due to incomplete desorption of the hydrocarbons, minute levels of hydrocarbons remain stored in the sorbent material of a purged evaporative canister. Bleed emissions are believed to result from the release of these stored hydrocarbons (i.e., the hydrocarbon heel) from the evaporative canister into the atmosphere. Bleed emissions typically occur, for example, during the heating of the fuel tank during a diurnal cycle. The heating of the fuel tank causes air to flow from the fuel tank, through the canister, out the vent port and into the atmosphere. The air carries the hydrocarbon heel out of the canister and into the atmosphere, thereby resulting in the release of bleed emissions.

In order to reduce bleed emissions some motor vehicles employ an auxiliary canister. The auxiliary canister is placed in series with and further filters the treated air flowing out the vent port of the main evaporative canister. The auxiliary canister typically uses the same sorbent material (i.e., granular or pelletized carbon) as is used in the main evaporative canister to thereby increase the hydrocarbon capacity of the evaporative emission control system. However, in order to achieve sufficient hydrocarbon capacity, auxiliary canisters are generally highly restrictive to the flow of air. Thus, the auxiliary canister must be bypassed in order to be compatible with vehicle refueling vapor recovery systems. Bypassing an auxiliary canister requires the addition of valves and conduits to the evaporative emissions control system, and thus adds cost and complexity to the system. Furthermore, the restrictive airflow characteristic of the auxiliary canister makes purging the volume of sorbent material inefficient, especially in small displacement engines. Moreover, vehicles which incorporate a more efficient evaporative canister and/or an auxiliary canister typically do not reduce bleed emissions to a level required to classify the vehicle as a Super Ultra Low Emissions Vehicle (SULEV) or as a Practically Zero Emissions Vehicle (PZEV).

As illustrated in FIG. 1, a prior art cell monolith 10, e.g., as disclosed in U.S. Pat. No. 5,914,294 to Park et al., has a plurality of passages 12 extending through the monolith 10 from a frontal end 14 to a rearward end 16. The passages 12 are formed by surrounding walls 18. The passages are encased by an outer skin 20. While this design is adequate for its intended purpose, there is a continued need for structurally sound monolith, which reduces bleed emissions and should have a low flow restriction, thereby increasing purge efficiency.

### SUMMARY

The drawbacks and disadvantages of the prior art are overcome by the exemplary embodiments of a cell within a cell monolith structure for an evaporative emissions hydrocarbon scrubber. A monolith for use in an evaporative emissions hydrocarbon scrubber is disclosed. A shell is concentrically disposed around a monolith. The monolith has at least one cell group disposed around at least two individual cells, such that the cell group comprises at least three thick walls. The individual cells comprise at least one thin wall, with the thick walls being thicker than the thin wall.

The method for using the evaporative emissions hydrocarbon scrubber is also disclosed. The method comprises introducing a gas to a first end of a monolith comprising carbon. The monolith, which is concentrically disposed within a shell, has at least one cell group disposed around at least two individual cells. The cell group comprises at least three thick walls, and the individual cells comprises at least one thin wall. The thick wall is thicker than the thin wall. Hydrocarbons are removed from the gas with the monolith prior to exhausting the gas through a second end of the monolith. The hydrocarbons can be removed from the monolith by passing air from the second end through the monolith and out the first end.

### BRIEF DESCRIPTION OF THE DRAWINGS

Referring now to the figure, which is meant to be exemplary, not limiting.

FIG. 1 is a perspective view of a prior art cell monolith structure.

FIG. 2 is a cross-sectional view of the cell within a cell monolith structure.

### DETAILED DESCRIPTION OF THE PREFERRED EMBODIMENTS

When evaporative emissions are released from the fuel tank due to diurnal pressure and/or temperature changes, the emissions can be captured in an evaporative canister. The monolith can be employed in the main evaporative canister, an auxiliary canister, or a combination thereof. While different designs of monoliths exist, including circular or rectangular designs, reference to a particular monolith design is intended to also represent similar components in other monolith designs, where applicable. Additionally, this monolith design can be employed as a single and only canister, or in conjunction with additional canisters.

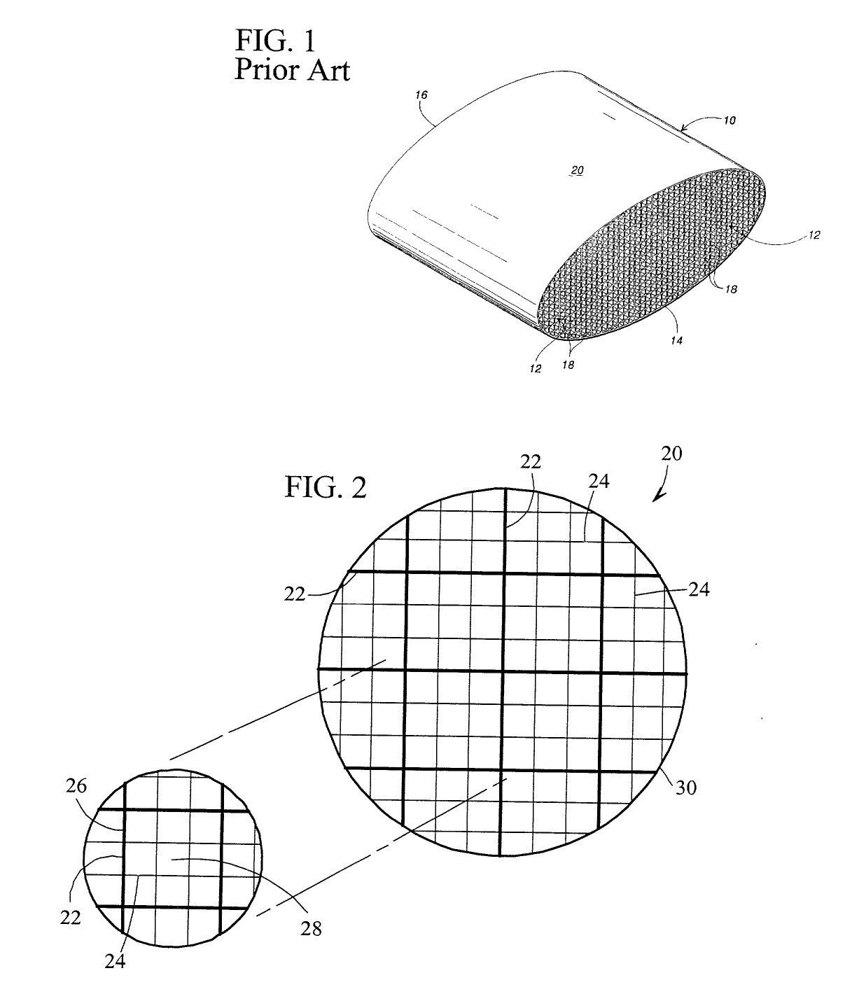

FIG. 1 illustrates a cross-sectional view of the cell within a cell monolith structure 20 for an evaporative emissions hydrocarbon scrubber. The monolith 20 comprises a combination of thin walls 24 and thick walls 22. These walls, which preferably run the length of the monolith 20, can be disposed perpendicular to the axis of the monolith. Typically, the walls 22, 24 are disposed horizontal and vertical, at an angle perpendicular to the axis. The thicker walls 22 define cell groups 26 comprising several cells 28 defined by the thin walls 24. Depending upon the specific size and geometry of the monolith, the number of connected main cell groups 26 can vary. The quantity of thin and thick walls is a balance between the desired structural integrity and the surface area desired to adsorb a sufficient amount of hydrocarbons in the fuel vapors. Generally, there are more thinner walls 24 disposed within the monolith 20 than thicker walls 22.

The geometry of the cells, both those defined by thick walls 22 and those defined by thin walls 24, is also based upon the desired structural integrity, surface area, and optionally upon ease of manufacture. Possible designs range from rounded to multi-sided figures, e.g., square, rectangle, oblong, circular, triangular, hexagonal, octagonal, and the like, as well as combinations comprising at least one of the foregoing geometries defining either the individual cells 28 and/or the main cell groups 26. For example, the interlaced thick and thin walls 22, 24 can perpendicularly intersect creating a square design as illustrated by individual cell 28, with the exception of when the interlaced thick and thin walls 22, 24 intersect with the outer wall 30. Additionally, the thin walls 24 can form different shaped cells than the cell groups 26. For example, the cell group 26 may comprise a rectangular geometry while the cells 28 within the cell group 26 may comprise a square geometry.

The location and orientation of the thick and thin walls 22, 24 can be dependent upon the overall shape of the monolith 20, such as, e.g., circular, oval, rectangular, trapezoidal, non-circular, and other similar geometric configurations, and the like. The cell shape and size is based upon the overall cell density. The number of cells within the monolith can be about 200 to about 600 individual cells, with about 200 to about 400 individual cells preferred. The number of individual cells within each cell group can vary, with at least four individual cells per cell group preferred, and at least nine individual cells per cell group especially preferred.

The thickness of the thick and thin walls 22, 24 is typically dependent upon the desired overall structural integrity of the monolith 20. The thickness is preferably sufficient to impart the desired overall structural integrity, without inhibiting the passage of evaporative emissions. Preferably, the thickness of the thicker walls 22 can be about 0.008 inches (in.) or greater, with about 0.008 in. to about 0.020 in. preferred, and about 0.010 in. to about 0.012 in. especially preferred. The thickness of the thinner walls 24 can be less than about 0.008 in., with about 0.001 in. to about 0.008 in. preferred, and about 0.003 in. to about 0.004 in. especially preferred.

The monolith 20 can be comprised of a sorbent that removes hydrocarbons from an air/vapor flow, including, but not limited to, activated carbon, and the like. This sorbent can be mixed with a binder to allow for the formation into the desired shape. The various amounts of sorbent and binder can readily be determined by an artisan based upon the desired structural integrity of the monolith and the monolith production method. One example of a monolith production process is disclosed in U.S. Pat. No. 5,914,294 to Park et al., which is hereby incorporated by reference.

Once formed into the cell within a cell structure, the monolith is concentrically disposed within a shell or housing (i.e., a canister), and disposed in fluid communication with the fuel tank and the atmosphere external to the motor vehicle. During operation, fuel vapor and air flow into a first end of the canister, and through the monolith, where the sorbent strips the hydrocarbons from the gas stream, releasing the treated air to the atmosphere. The canister is fluidly connected by a valved purge conduit to the combustion air intake of the motor vehicle engine. When the engine is running, the combustion air intake is at sub-atmospheric pressure, and the valve is opened to thereby connect the purge port to the combustion air intake. Fresh air is drawn by the sub-atmospheric pressure through the vent port and into the second end of the evaporative canister. The fresh air flows through the monolith, stripping the sorbent of stored hydrocarbons.

The thinner walls 24 increases the desorption capability of the monolith 20, allowing for a more thorough cleaning of the monolith of hydrocarbons. The performance of the monolith 20 improves as the desorption capability is increased, since the ability to capture the fuel vapor and/or hydrocarbons is more rapidly restored. The use of the thicker walls 22, defining the main cell groups 26, increases the structural integrity of the monolith 20 without compromising the open area for air flow. The plurality of the main cell groups 26 does not add any significant pressure differential across the monolith 20, when compared to a monolith with uniform thicknesses, as illustrated in the prior art FIG. 1.

While preferred embodiments have been shown and described, various modifications and substitutions may be made thereto without departing from the spirit and scope of the invention. Accordingly, it is to be understood that the apparatus and method have been described by way of illustration only, and such illustrations and embodiments as have been disclosed herein are not to be construed as limiting to the claims.

What is claimed is:

1. An evaporative emissions hydrocarbon scrubber, comprising:
a monolith comprising carbon having at least one cell group disposed around at least two individual cells, wherein said cell group comprises at least three thick walls, and said individual cells comprising at least one thin wall, said thick wall being thicker than said thin wall; and
a shell concentrically disposed around said monolith.

2. The evaporative emissions hydrocarbon scrubber of claim 1, wherein said thick walls are greater than about 0.008 in. to about 0.020 in. in thickness.

3. The evaporative emissions hydrocarbon scrubber of claim 2, wherein said thick walls are about 0.010 in. to about 0.012 in. in thickness.

4. The evaporative emissions hydrocarbon scrubber of claim 1, wherein said thin walls are about 0.001 in. up to about 0.008 in. in thickness.

5. The evaporative emissions hydrocarbon scrubber of claim 4, wherein said thin walls are about 0.003 in. to about 0.004 in. in thickness.

6. The evaporative emissions hydrocarbon scrubber of claim 1, wherein said monolith further comprises activated carbon and a binder.

7. The evaporative emissions hydrocarbon scrubber of claim 1, wherein at least four of said individual cells are disposed within each of said cell groups.

8. The evaporative emissions hydrocarbon scrubber of claim 1, wherein at least nine of said individual cells are disposed within each of said cell groups.

9. The evaporative emissions hydrocarbon scrubber of claim 1, wherein said monolith comprises about 200 to about 600 of said individual cells.

10. The evaporative emissions hydrocarbon scrubber of claim 9, wherein said monolith comprises about 200 to about 400 of said individual cells.

11. A method for using an evaporative emissions hydrocarbon scrubber, comprising:
introducing a gas to a first end of a monolith comprising carbon, said monolith having at least one cell group disposed around at least two individual cells, wherein said cell group comprises at least three thick walls, and said individual cells comprising at least one thin wall, said thick wall being thicker than said thin wall, said monolith concentrically disposed within a shell;
removing hydrocarbons from said gas;
exhausting said gas through a second end of said monolith;
introducing air through said second end of said monolith; and
removing said hydrocarbons from said monolith.

12. The method of claim 11, wherein said monolith further comprises activated carbon and a binder.
